(19) United States
(12) Patent Application Publication
(10) Pub. No.: US 2025/0152458 A1
(43) Pub. Date: May 15, 2025

(54) Massage device and operating method thereof

(71) Applicant: HYTTO PTE. LTD.

(72) Inventors: Dan LIU, Guangzhou (CN); Jilin QIU, Guangzhou (CN)

(73) Assignee: HYTTO PTE. LTD., (omitted)

(21) Appl. No.: 18/509,284

(22) Filed: Nov. 14, 2023

(51) Int. Cl. A61H 19/00

(52) U.S. Cl. CPC A61H 19/44; A61H 2201/5064; A61H 2201/5097

(57) ABSTRACT

A massage device and a method of operating the massage device are provided. The massage device includes a casing comprising a contact region, a sensor disposed in the casing and configured to detect a status of a contact region, and a stimulator at least partially disposed in the casing and configured to execute a predetermined action in response to the status of the contact region.

### BACKGROUND

The present disclosure relates to a massage device, and an operating method thereof.

Massage devices are widely used for health benefits, such as relaxation, pain relief, and sexual gratification. When pressed against a human body, a massage device transmits its vibration to the contacted portion of the human body. The vibration may mimic a massage by hands, fingers, elbows, knees, forearms, feet, or any other body part of a massage therapist.

For many types of massage devices, the operator has to hold the devices by hand in order to make contact with the human body. Sometimes the vibration exceeds the maximum frequency achievable by a human being. While such vibration may realize health benefits that are not easily obtainable from human massaging, it often causes soreness or numbness to the hands of the operator. In addition, the vibration of conventional self-massage devices is not easily controllable as it requires additional actions from the operator that could interrupt his or her enjoyment.

### SUMMARY

In one aspect, embodiments of the present disclosure provide a massage device. The massage device includes a casing comprising a contact region, a sensor disposed in the casing and configured to detect a status of a contact region, and a stimulator at least partially disposed in the casing and configured to execute a predetermined action in response to the status of the contact region.

In another aspect, embodiments of the present disclosure provide a method for operating a massage device. The method includes detecting a status of a contact region of the massage device by a sensor, and in response to the status of the contact region of the massage device, executing a predetermined action by a stimulator.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1 illustrates a block diagram of an exemplary system applicable to a massage device, according to some implementations of the present disclosure.

FIG. 2A illustrates a schematic diagram of an exemplary massage device, according to some implementations of the present disclosure.

FIG. 2B illustrates a schematic diagram of an exemplary massage device, according to some implementations of the present disclosure.

FIG. 2C illustrates a schematic diagram of an exemplary massage device, according to some implementations of the present disclosure.

FIG. 2D illustrates a schematic diagram of an exemplary massage device, according to some implementations of the present disclosure.

FIG. 2E illustrates a schematic diagram of an exemplary massage device, according to some implementations of the present disclosure.

FIG. 2F illustrates a schematic diagram of an exemplary massage device, according to some implementations of the present disclosure.

FIG. 3A illustrates a schematic diagram of an exemplary massage device including an exemplary interconnect structure, according to some implementations of the present disclosure.

FIG. 3B illustrates a schematic diagram of an exemplary massage device including an exemplary interconnect structure, according to some implementations of the present disclosure.

FIG. 3C illustrates a schematic diagram of an exemplary massage device including an exemplary interconnect structure, according to some implementations of the present disclosure.

FIG. 3D illustrates a schematic diagram of an exemplary massage device including an exemplary interconnect structure, according to some implementations of the present disclosure.

FIG. 3E illustrates a schematic diagram of an exemplary massage device including an exemplary interconnect structure, according to some implementations of the present disclosure.

FIG. 4 illustrates a flowchart for operating an exemplary massage device, according to various embodiments of the present disclosure.

The present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications. Functional and structural features as described in the present disclosure can be combined, adjusted, and modified with one another and in ways not specifically depicted in the drawings, such that these combinations, adjustments, and modifications are within the scope of the present disclosure.

It is noted that references in the specification to “one embodiment,” “an embodiment,” “one example,” “an example,” “one implementation,” “an implementation,” “some embodiments,” “some examples,” “some implementations,” etc. indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to effect such feature, structure or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context.

A massage device (also known as body massager, sex toy, or vibrator) can be used on the body to produce pleasurable sexual stimulation. There are various types of massage devices. They can be hand-held types of massage devices, such as phallic devices, dildos, massage wands, artificial vaginas, etc. They can also be hand-free types of massage device such as panty vibrators, wearable toys, etc. Generally, the vibration intensity of a massage device may be adjusted by a switch button provided on or connected to the massage device or an application through remote control. Such control is inconvenient for a user during the enjoyment and cannot be adjusted freely and immediately according to the user's needs to achieve ultimate pleasurable experience. Furthermore, hand-held massage devices have to be held by hands or fingers for a long time during the use, which tends to cause numbness, soreness, or pain to the hands or fingers of the operator. To achieve greater pleasure, it may also require additional pressure provided by hands or fingers, thereby increasing the numbness, soreness, or pain. In addition, the softness of the stimulating end or the hand-held end of the massage device is not enough so that it is not suitable for prolonged use.

To address one or more of the aforementioned issues, the present disclosure introduces a solution in which a stimulating end of the massage device is designed to be a sensing end, and in response to the stimulating end receiving a changing parameter (e.g., pressure, temperature, moisture, area of contact, etc.), the vibrations of the stimulating end change proportionally according to the parameter change. In one example, when a user presses the massage device against the body with increased strength, the massage device may generate feedback and provide intensified vibration. In another example, when the pressure decreases, the feedback of the massage device may cause the vibration intensity to decrease. It is noted that the present disclosure is not limited to the solutions and the implementations described above, various implementations disclosed in the present disclosure may also be combined, adjusted, or modified with one another as long as these combinations, adjustments, or modifications are within the scope of the present disclosure.

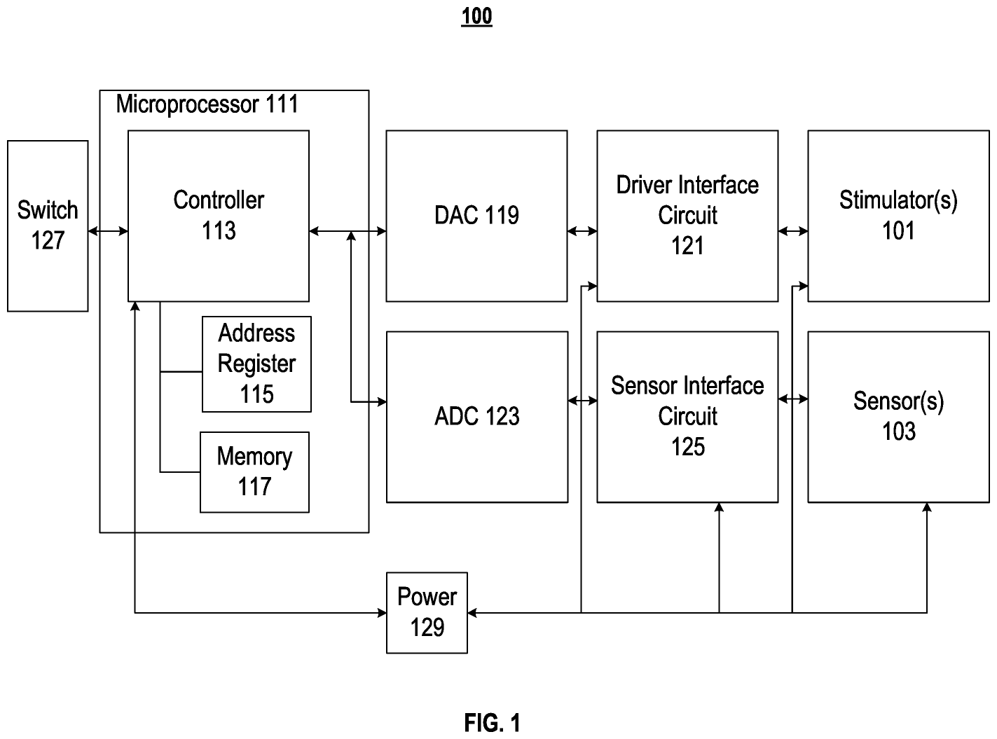

FIG. 1 illustrates a block diagram of an exemplary system 100 applicable to a massage device, according to some implementations of the present disclosure. As shown in FIG. 1, system 100 includes a processor or microprocessor 111, a stimulator 101 coupled to microprocessor 111, and a sensor 103 coupled to microprocessor 111.

In some implementations, microprocessor 111 may include a controller 113, and an address register 115 and a memory 117 coupled to controller 113. In some implementations, controller 113 includes microcontroller units (MCUs), digital signal processors (DSPs), application-specific integrated circuits (ASICs), field-programmable gate arrays (FPGAs), programmable logic devices (PLDs), state machines, gated logic, discrete hardware circuits, and other suitable hardware, firmware, and/or software configured to perform the various functions described below in detail. Address register 115 may include status registers, command registers, memory data registers, memory address registers, and control registers for storing status information, command operation codes (OP codes), memory data, memory addresses, and control command addresses for controlling the operations of system 100. Memory 117 may include any suitable solid-state, non-volatile memory, e.g., NOR Flash, ferroelectric RAM (FeRAM), phase-change memory (PCM), magnetic RAM (MRAM), spin tunnel torque RAM (STT MRAM), or resistive RAM (RRAM), etc.

Controller 113 may read out the information or signals received from sensor 103 and store the information or signals in memory 117 and/or address register 115. As such, controller 113 may cause stimulator 101 to perform operations according to the information or signals received. In some implementations, controller 113 is disposed inside the massage device, reads the status of a contact region of the massage device, and controls the stimulator 101 to execute one or more predetermined actions in response to the detected status. In some implementations, controller 113 includes a feedback circuit configured to provide feedback to the stimulator 101 according to a signal received from the contact region of the massage device. These features will be discussed in detail later.

In addition, as shown in FIG. 1, system 100 may also include a power 129 connected to microprocessor 111, stimulator 101, and sensor 103, and a switch 127 coupled to microprocessor 111. Power 129 may be a power interface connected to an external power source. The power interface includes a power cord, a voltage plug, or a power adaptor such as USB-C connector. Power 129 may also be a power supply provided inside or adjacent to the massage device, such as one or more batteries (e.g., rechargeable batteries or non-rechargeable batteries). Power 129 may provide electrical power to components of system 100, including but not limited to microprocessor 111, stimulator 101, and sensor 103. Switch 127 may control operations or modes of the massage device, including but not limited to on/off of the massage device, up/down of the vibration intensity, or increase/decrease of the vibration duration. Switch 127 may be implemented or controlled by button, touch panel, voice control, motion control, or control via application installed in a personal electronic device, such as a smartphone, a wearable device, a tablet, a laptop, or a desktop. For example, switch 127 may be used to control or switch the vibration mode by pressing the button a predetermined number of times.

In some implementations, system 100 may have wireless connectivity, which may be provided automatically by turning on switch 127 or may be controlled separately by other components. The wireless connectivity may allow operations of the massage device to be controlled at a location distant from the massage device by, for example, a personal electronic device installed with a control application, in which case the operator can be different from the user of the massage device.

In addition, as shown in FIG. 1, system 100 may further include a digital to analog converter (DAC) 119 coupled to microprocessor 111, a driver interface circuit 121 coupled between DAC 119 and stimulator 101. As such, a command or an instruction (e.g., a digital signal) received from microprocessor 111 may be converted to analog signals by DAC 119 and the analog signals may be used to drive stimulator 101 via driver interface circuit 121. It is noted that DAC 119 and driver interface circuit 121 can also be embedded into stimulator 101, microprocessor 111, or any other component in system 100.

In addition, as shown in FIG. 1, system 100 may further include an analog to digital converter (ADC) 123 coupled to microprocessor 111, a sensor interface circuit 125 coupled between ADC 123 and sensor 103. As such, a detected status or information (e.g., an analog signal) received from sensor 103 may be converted to digital signals by ADC 123 via sensor interface circuit 125 and the digital signals may be processed or analyzed by microprocessor 111. It is noted that ADC 123 and sensor interface circuit 125 can also be embedded into or integrated with sensor 103, microprocessor 111, or any other component in system 100.

Stimulator 101 may be implemented as a motor, a heat generator, an airflow generator, etc. When implemented as a motor, stimulator 101 may include a brushed motor, a brushless motor, a stepper motor, any other motor suitable for system 100 or the massage device according to the present disclosure, or a combination of two or more of these motors. A motor-type stimulator 101 may vibrate, protrude, retract, or move in any other manner that causes periodic or intermittent contact between a contact region of the massage device and a portion of a human body. When implemented as a heat generator, stimulator 101 may provide heat to the contact region of the massage device, which can be transmitted onward to the human body via physical contact or thermal radiation between the massage device and the human body. When implemented as an airflow generator, stimulator 101 may provide airflow through the contact region of the massage device towards the human body during operation of the massage device, with or without physical contact between the massage device and the human body. It is noted that there may be more than one stimulator 101 (e.g., multiple stimulators 101) in system 100. When more than one stimulator 101 is present in system 100, they can be the same type or different types of the abovementioned stimulators. In one example, one stimulator may be a motor-type stimulator, another stimulator may be an airflow generator, and the two stimulators may sequentially or concurrently function to stimulate the human body.

Sensor 103 may include mechanical sensors, electronic sensors, pressure sensors, proximity sensors, inductive sensors, capacitive sensors, RF (such as RF ID) sensors, optical sensors (such as infrared (IR) sensors), audio sensors, magnetic sensors, Hall effect sensors, moisture sensors, heat detectors, any other sensor suitable for system 100 or the massage device according to the present disclosure, or a combination of two or more of these sensors. It is noted that there may be more than one sensor 103 (e.g., multiple sensors 103) in system 100. In some implementations, sensor 103 is configured to detect at least one of the following parameters at, near or from the contact region of the massage device: temperature, moisture, external pressure, area of contact, or any other status or information detectable by sensor 103. The external pressure indicates the pressure received by the massage device at or from its contact region. The area of contact indicates the size of the contacted portion between the massage device and the human body, and the area of contact may vary when the massage device is pushed against the human body with different levels of strength.

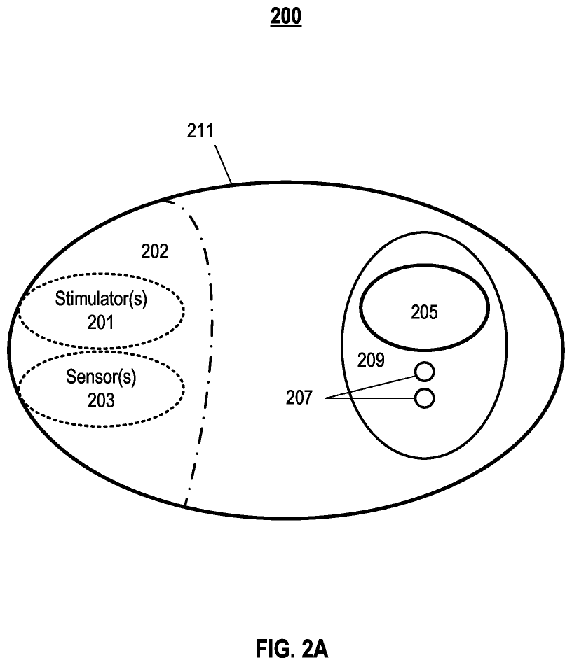

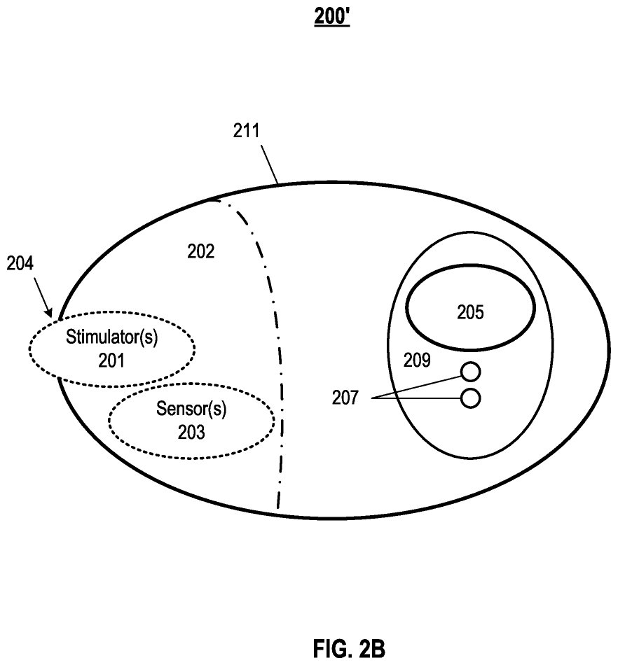

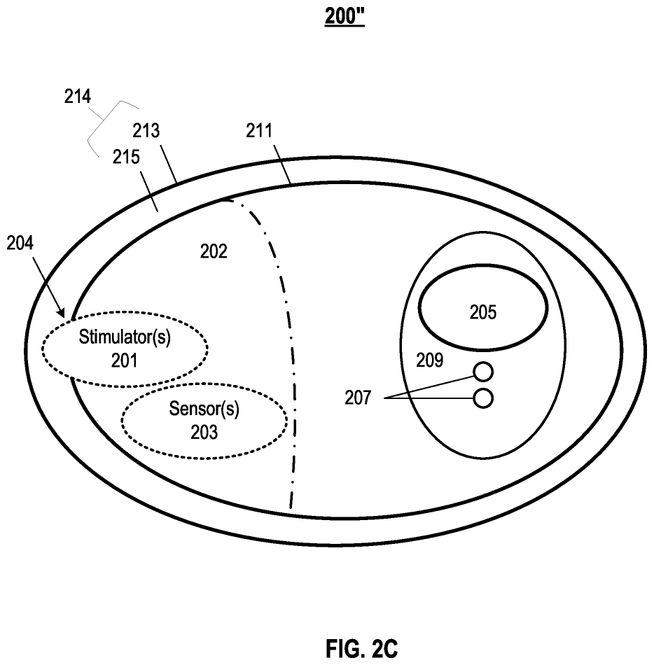

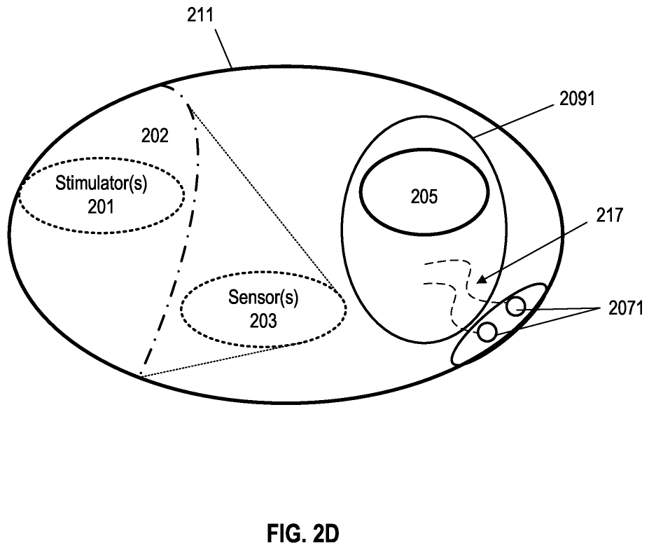

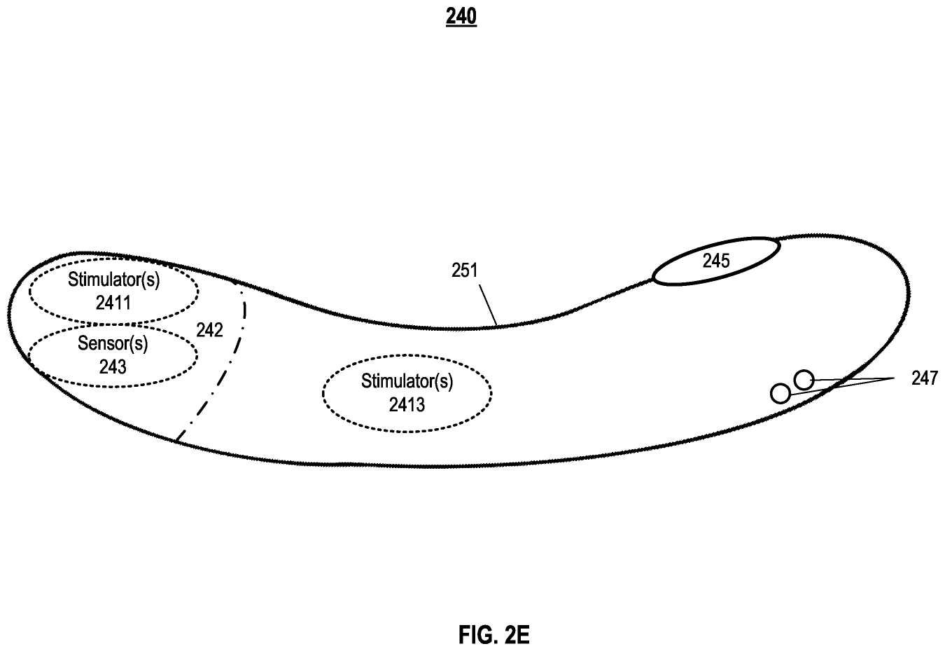

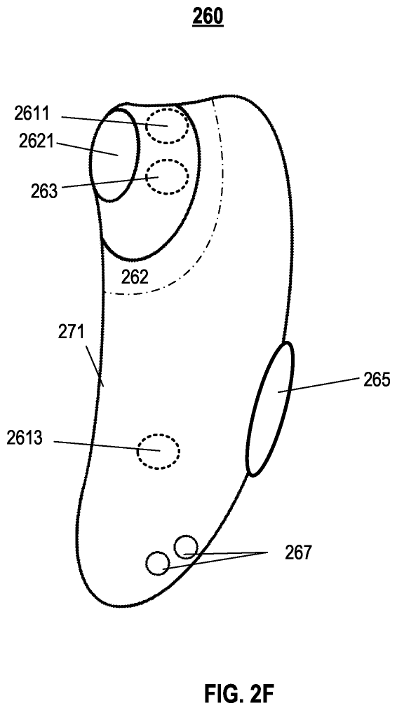

FIG. 2A illustrates a schematic diagram of an exemplary massage device 200, according to some implementations of the present disclosure. FIG. 2B illustrates a schematic diagram of an exemplary massage device 200′, according to some implementations of the present disclosure. FIG. 2C illustrates a schematic diagram of an exemplary massage device 200″, according to some implementations of the present disclosure. In some implementations, massage device 200, 200′ or 200″ may be a small massage device that can be held by one hand or palm, such as a mini vibrator, a mini massage wand, a soft touch vibrator, a wearable vibrator, or a panty vibrator.

As shown in FIG. 2A, massage device 200 may include a casing 211 with a contact region 202 in a first end (e.g., a stimulating end) of massage device 200. A stimulator 201 (e.g., an implementation of stimulator 101 in FIG. 1), a sensor 203 (e.g., an implementation of sensor 103 in FIG. 1), and a controller (e.g., an implementation of controller 113 in FIG. 1) may be disposed in casing 211.

When implemented as a motor, stimulator 201 may perform one or more functions, such as vibration, protrusion, retraction, or movement in any other manner that causes periodic or intermittent contact between contact region 202 and a portion of a human body. In some implementations, with massage device 200 turned on, the vibration, protrusion, retraction, or any other movement may not immediately commence until an initial contact between contact region 202 and the body portion is detected. This configuration has the benefit of saving power and increasing operational efficiency. In some other implementations, massage device 200 may be activated or start to vibrate, protrude, retract, or move in any other manner upon being turned on, and the intensity or manner of such movement may be changed upon contact between contact region 202 and the body portion. When massage device 200 is being applied to his or her body, a user may enjoy pleasurable massaging experience caused by the contact.

In some implementations, stimulator 201 may have a heat generator coupled thereto or embedded therein so as to provide heat to contact region 202. The heat may be transmitted to the human body via physical contact, or via thermal radiation within certain proximity to the human body. In some implementations, stimulator 201 may have an airflow generator coupled thereto or embedded therein so as to provide airflow via contact region 202. The airflow may be provided with or without physical contact.

It is noted that stimulator 201 may include one or more types of motor, heat generator, or airflow generator. For example, when both a motor and a heat generator are implemented in stimulator 201, upon contact with the human body, massage device 200 may vibrate while simultaneously transmitting heat via contact region 202. Alternatively, massage device 200 may increase its temperature around contact region 202 before physically contacting the human body, and subsequently vibrate upon contact while heat ceases to be generated. With the teaching of the present disclosure, those skilled in the art may understand that the specific examples of stimulator 201 described herein do not constitute exhaustive examples of stimulator 201, which may include more or fewer components than illustrated, combine some of the illustrated components, or have a different component arrangement.

Sensor 203 is configured to detect a status of contact region 202. The status of contact region 202 may include one or more of the following parameters: temperature, moisture, external pressure, or area of contact. For example, when implemented as a heat detector, sensor 203 is able to detect temperature of contact region 202. Sensor 203 may also measure the pressure exerted on contact region 202 when implemented as a pressure sensor. To detect different parameters, sensor 203 may be implemented as different types of sensors, which have been described above in conjunction with sensor 103 and thus will not be repeated herein. According to the present disclosure, sensor 203 is not only capable of measuring the absolute value of one or more of the parameters, but also detecting a change thereof. The change may trigger an action of massage device 200 that is proportional to the change.

Stimulator 201 may be further configured to execute a predetermined action in response to the status of contact region 202. The predetermined action includes providing or adjusting at least one of vibration, protrusion, retraction, heat, or airflow via contact region 202. For example, when massage device 200 is pressed against a human body, sensor 203 detects pressure being exerted on contact region 202 of massage device 200, and consequently stimulator 201 starts to vibrate. As massage device 200 is pressed with more strength against the body, sensor 203 can detect increase of the pressure and the vibration of stimulator 201 becomes more intense (e.g., with shorter interval, longer duration, or stronger force). As massage device 200 is pressed with less strength against the body, sensor 203 can detect decrease of the pressure and the vibration of stimulator 201 becomes more tender (e.g., with longer interval, shorter duration, or gentler force). When massage device 200 is taken away and no longer contacts the body, sensor 203 does not detect any pressure, and consequently stimulator 201 stops the vibration. In another example, stimulator 201 may be activated or start to vibrate at a certain vibration intensity, which is known as an induction mode, before massage device 200 contacts a human body. When massage device 200 is pressed against the human body, sensor 203 detects pressure being exerted on contact region 202 of massage device 200, the vibration of stimulator 201 becomes more intense than that in the induction mode. When massage device 200 is moved away from the human body, sensor 203 can detect disappearance of the pressure, and the vibration of stimulator 201 returns to the intensity level in the induction mode.

According to the present disclosure, in response to a change of one of the parameters detected by sensor 203, stimulator 201 may deliver vibrations via contact region 202 proportional to the change of the detected parameters. In some implementations, sensor 203 obtains a pressure level upon initial contact between massage device 200 and the human body, and when sensor 203 detects steeper pressure change on contact region 202, the vibration intensity of stimulator 201 changes more dramatically. The change of vibration intensity can be linear or non-linear, depending on a control algorithm provided in the system of massage device 200. The control algorithm can be pre-programmed and stored in the address register or memory, or can be transferred to the system from outside massage device 200. When the change of vibration intensity is non-linear, it can still be regarded as proportional to the change of the detected parameters, as long as the change of vibration intensity follows a pattern that distinguishes among various degrees or extents of the parameter change.

Contact region 202 may include at least a portion of an outer surface of casing 211 and is configured to be in contact with a human body. In some implementations, as shown in FIG. 2A, both stimulator 201 and sensor 203 may be underneath the portion of the outer surface of casing 211. Simulator 201 is covered by the outer surface of casing 211 and does not physically get in touch with the human body. Nonetheless, the vibration, heat, or airflow generated by stimulator 201 can be transmitted to the human body via contact region 202. In some implementations, as shown in FIG. 2B, casing 211 may have an opening 204 at contact region 202. Stimulator 201 may be at least partially exposed at opening 204. The exposure allows stimulator 201 to protrude beyond the first end of casing 211. In cases where stimulator 201 itself is configured to protrude or retract as a motor, stimulator 201 may protrude via opening 204 to the maximum extent so that opening 204 is completely or almost completely blocked by stimulator 201.

As shown in FIG. 2C, in some implementations, casing 211 may be at least partially enclosed by a cover 214. Cover 214 may have a similar or same shape as casing 211. In some implementations, cover 214 wraps around all or substantially all of the outer surface of casing 211, thereby protecting casing 211 and the inner components of massage device 200″ from being damaged during use. Alternatively, cover 214 may be a head cover that only wraps around contact region 202. In some implementations, cover 214 may include a material softer than the material of casing 211. In one example, the soft material of cover 214 is provided to cover at least contact region 202, which can reduce stiffness when massage device 200″ touches the human body and more closely resemble human massaging experience. In another example, the soft material makes up the entire cover 214 so that the handheld portion of massage device 200″ is also covered by the soft material, which can reduce numbness, soreness, or pain of the operator's hands or fingers. In some implementations, cover 214 is detachably attached to casing 211. For example, cover 214 may be peeled off from casing 211. The detached cover 214 may be exchangeable with other cover that may or may not have the similar configuration or material as the detached cover 214.

In some implementations, cover 214 may include an outer shell 213 and an elastic layer 215. Elastic layer 215 is provided between outer shell 213 and casing 211 and may serve as an intermediate layer therebetween. The composition and material of outer shell 213 and elastic layer 215 may have various implementations. In one example, elastic layer 215 is integrated with outer shell 213, either during the manufacturing process or via a bonding technique, so that they can be detached from casing 211 together. The material of elastic layer 215 may be the same as that of outer shell 213, making the manufacturing process easier. Alternatively, the material of elastic layer 215 may be softer than that of outer shell 213, thus functioning as a cushion that provides additional comfort to the user of massage device 200″. In another example, elastic layer 215 may be separate from outer shell 213. Similar to the previous example, the materials of these two components may or may not be the same. Outer shell 213 may be detached from casing 211 independently from elastic layer 215. As a result, outer shell 213 and elastic layer 215 may be separately exchanged with a replacement part. In case where one of the two components is damaged or malfunctions, this configuration does not require replacement of the entire cover 214.

In some implementations, at least one of cover 214, outer shell 213, or elastic layer 215 may have an opening that matches opening 204 shown in FIG. 2B. This allows stimulator 201 to be at least partially exposed not only from casing 211 but also from at least one of cover 214, outer shell 213, or elastic layer 215 that has the opening. In one example, stimulator 201 may protrude beyond casing 211 and elastic layer 215 via their respective openings, but not outer shell 213. Thus, contact region 202 may be in touch with the body portion with only outer shell 213 in-between, resulting in more sensitive receiving of parameters, such as temperature, moisture, external pressure, or area of contact. In another example, stimulator 201 may protrude beyond casing 211 and cover 214 (which may include elastic layer 215 and outer shell 213) via their respective openings, causing direct contact between stimulator 201 and the body portion and maximizing stimulation generated by the massage device.

In some implementations, as shown in FIGS. 2A to 2C, massage device 200, 200′, and 200″ may each include at least one of a button 205 or a charging port 207 disposed on a control region 209 of casing 211. Control region 209 may be provided in the second end (e.g., the hand-held end) of casing 211. The second end is an end different from (e.g., opposite to) the first end. Button 205 may be configured to control on/off of the massage device. In some implementations, button 205 may also control the mode of action of stimulator 201. For example, a user pressing button 205 is able to switch among different modes of vibration, and each mode of vibration varies by at least one of intensity, duration, frequency, etc. Pressing button 205 may also switch between different types of stimulation, such as stimulation by vibration, heat, or airflow. It is noted that button 205 may be implemented as more than one button according to some implementations of the present disclosure. Charging port 207 may be used to charge an internal power source (e.g., power 129 described in conjunction with FIG. 1) of the massage device. It may be connected to an AC power outlet or a DC power supply. Although FIGS. 2A to 2C illustrate charging port 207 with two connecting points, a person skilled in the pertinent art would understand, with the teaching disclosed herein, that other implementations of charging port 207 may also be applied to the massage device according to the present disclosure, such as USB, USB Type-C, etc.

In some implementations, a controller (e.g., controller 113 in FIG. 1) may be disposed in casing 211 and configured to read the status of contact region 202 and control stimulator 201 to execute the predetermined action in response to the status of contact region 202. The controller may include a feedback circuit configured to provide feedback to stimulator 201 according to a signal received from contact region 202, which represents the detected status of contact region 202. For example, when a user presses massage device 200 against a human body via contact region 202, sensor 203 may generate a signal indicating that contact region 202 is being pushed or squeezed. The signal is then transmitted to the feedback circuit in the controller, and the feedback circuit provides feedback to stimulator 201. The signal may also include a value range indicating the level of pressure being exerted on contact region 202, As a result, stimulator 201 may change the intensity of its vibrations proportionally to the change of the level of pressure detected by sensor 203 thanks to the feedback circuit of the controller.

FIG. 2D illustrates a schematic diagram of an exemplary massage device 220, according to some implementations of the present disclosure. As discussed above and shown in FIG. 2A, sensor 203 and stimulator 201 may be disposed in the first end (e.g., the stimulating end) of casing 211. The exact locations of sensor 203 and stimulator 201 in the massage device are not limited to the example shown in FIG. 2A. As shown in FIG. 2D, stimulator 201 may be disposed in the first end (e.g., the stimulating end) of casing 211 while sensor 203 is disposed in a second end (e.g., a hand-held end) of casing 211. This configuration may create more design latitude for stimulator 201. Also, the layout of button 205 and charging port 2071 shown in FIG. 2D is different from that of button 205 and charging port 207 shown in FIGS. 2A to 2C. In this example, only button 205 is disposed on a control region 2091 of casing 211, while charging port 2071 is disposed on another region of casing 211. Charging port 2071 may be electrically coupled to control region 2091 by one or more wire leads 217. Wire leads 217 may be enclosed within casing 211 or embedded in wire grooves (not shown) on the surface of casing 211. When a cover (similar to that shown in FIG. 2C) wraps around all or substantially all of the outer surface of casing 211, wire leads 217 may also be hidden beneath the cover and along the wire grooves. Therefore, wire leads 217 are protected by the cover from external damage or interference, enabling stable electrical connection between charging port 2071 and internal components of the massage device.

In some implementations, cover 214 may have one or more openings in a surface region corresponding to at least one of the control region (e.g., control region 209/2091 shown in FIGS. 2A to 2D), the button (e.g., button 205 shown in FIGS. 2A to 2D), or the charging port (e.g., charting port 207/2071 shown in FIGS. 2A to 2D). For example, charging port 2071 in FIG. 2D may be exposed by an opening of cover 214 so that it can be connected to the external electrical power, and button 205 may also be exposed by a different opening of cover 214 so that it can be pressed by physical contact. In another example, the entire control region 209 in FIG. 2C may be exposed by an opening of elastic layer 215 and an opening of outer shell 213, and thus button 205 can be physically touched by an operator or massage device 200″ and charging port 2071 can be connected to the external electrical power. In any of the implementations, an additional detachable cap (not shown) may be provided at each location of the one or more openings, so that the underlying surface (including the exposed components, such as button 205, charting port 207/2071, etc.) can be protected when the massage device is in use and exposed when charging or button pressing becomes necessary.

FIG. 2E illustrates a schematic diagram of an exemplary massage device 240, according to some implementations of the present disclosure. In some implementations, massage device 240 may be an elongated massage device, such as a rabbit vibrator, a dildo, a massage wand, a g-spot vibrator, or a bullet vibrator.

As shown in FIG. 2E, massage device 240 may include a casing 251 (e.g., an elongated casing) with a contact region 242 in a first end (e.g., a stimulating end) of massage device 240. A first stimulator 2411 (e.g., an implementation of stimulator 101 in FIG. 1 or stimulator 201 in any of FIGS. 2A to 2D), a sensor 243 (e.g., an implementation of sensor 103 in FIG. 1 or sensor 203 in any of FIGS. 2A to 2D), a second stimulator 2413 (e.g., an implementation of stimulator 101 in FIG. 1 or stimulator 201 in any of FIGS. 2A to 2D), and a controller (e.g., an implementation of controller 113 in FIG. 1) may be disposed in casing 251.

When implemented as a motor, first stimulator 2411 may perform one or more functions, such as vibration, protrusion, retraction, or movement in any other manner that causes periodic or intermittent contact between contact region 242 and a portion of a human body. In some implementations, with massage device 240 turned on, the vibration, protrusion, retraction, or any other movement may not immediately commence until an initial contact between contact region 242 and the body portion is detected. This configuration has the benefit of saving power and increasing operational efficiency. In some other implementations, massage device 240 may be activated or start to vibrate, protrude, retract, or move in any other manner upon being turned on, and the intensity or manner of such movement may be changed upon contact between contact region 242 and the body portion. When massage device 240 is being applied to his or her body, a user may enjoy pleasurable massaging experience caused by the contact.

In some implementations, first stimulator 2411 may have a heat generator coupled thereto or embedded therein so as to provide heat to contact region 242. The heat may be transmitted to the human body via physical contact, or via thermal radiation within certain proximity to the human body. In some implementations, first stimulator 2411 may have an airflow generator coupled thereto or embedded therein so as to provide airflow via contact region 242. The airflow may be provided with or without physical contact.

It is noted that first stimulator 2411 may include one or more types of motor, heat generator, or airflow generator. For example, when both a motor and a heat generator are implemented in first stimulator 2411, upon contact with the human body, massage device 200 may vibrate while simultaneously transmitting heat via contact region 242. Alternatively, massage device 240 may increase its temperature around contact region 242 before physically contacting the human body, and subsequently vibrate upon contact while heat ceases to be generated. With the teaching of the present disclosure, those skilled in the art may understand that the specific examples of first stimulator 2411 described herein do not constitute exhaustive examples of first stimulator 2411, which may include more or fewer components than illustrated, combine some of the illustrated components, or have a different component arrangement.

Similar to first stimulator 2411, second stimulator 2413 may also perform one or more functions, such as vibration, protrusion, retraction, or movement in any other manner, but at a region different from contact region 242. The region may be located at a second end (e.g., a hand-held end) of casing 251. Second stimulator 2413 may be implemented as one or more of a motor, a heat generator, an airflow generator, or a combination of any of these types of stimulators. It is noted that second stimulator 2413 is only an exemplary implementation in massage device 240. In some implementations, second stimulator 2413 may be omitted.

Similar to sensor 203 in FIGS. 2A to 2D, sensor 243 is configured to detect a status of contact region 242. The status of contact region 242 may include one or more of the following parameters: temperature, moisture, external pressure, or area of contact. For example, when implemented as a heat detector, sensor 243 is able to detect temperature of contact region 242. Sensor 243 may also measure the pressure exerted on contact region 242 when implemented as a pressure sensor. To detect different parameters, sensor 243 may be implemented as different types of sensors, which have been described above in conjunction with sensor 103 and thus will not be repeated herein. According to the present disclosure, sensor 243 is not only capable of measuring the absolute value of one or more of the parameters, but also detecting a change thereof. The change may trigger an action of massage device 240 that is proportional to the change.

At least one of first stimulator 2411 or second stimulator 2413 may be further configured to execute a predetermined action in response to the status of contact region 242. The predetermined action includes providing or adjusting at least one of vibration, protrusion, retraction, heat, or airflow via contact region 242. The examples for one particular stimulator are similar to stimulator 201 discussed in conjunction with FIGS. 2A to 2D, and thus will not be repeated herein. It is noted that since first stimulator 2411 and second stimulator 2413 are distinct components of massage device 240, the predetermined actions executed by these two stimulators may or may not be the same. In some implementations, in response to a change of one of the parameters detected by sensor 243, the executed action may be proportional to the change of the detected parameters, which is similar to that discussed in conjunction with FIGS. 2A to 2D.

Similar to contact region 202, contact region 242 may include at least a portion of an outer surface of casing 251 and is configured to be in contact with a human body. In some implementations, as shown in FIG. 2E, both first stimulator 2411 and sensor 243 may be underneath the portion of the outer surface of casing 251. In some implementations, similar to that shown in FIG. 2B, casing 251 may have an opening (not shown) at contact region 242, so that first stimulator 2411 may be at least partially exposed at the opening. Similar to cover 214, in some implementations, casing 251 may be at least partially enclosed by a cover (not shown) at contact region 242. The material of the cover is softer than that of casing 251. In some implementations, the cover may include an outer shell (similar to outer shell 213) and an elastic layer (similar to elastic layer 215). In some implementations, at least one of the cover, the outer shell, or the elastic layer is detachable from casing 251. In some implementations, at least one of the cover, the outer shell, or the elastic layer has an opening that matches the opening of casing 251.

In some implementations, as shown in FIG. 2E, massage device 240 may further include at least one of a button 245 or a charging port 247 disposed on casing 251. It is noted that the locations and electric connectivity (e.g., via wire leads) of button 245 and charging port 247 may be the same as or similar to those discussed in conjunction with FIGS. 2A to 2D, and thus will not be repeated herein.

As shown in FIG. 2E, a controller (e.g., controller 113 in FIG. 1) may be disposed in casing 251 and configured to read the status of contact region 242 and control first stimulator 2411 and second stimulator 2413 to execute the predetermined action in response to the status of contact region 242. The controller may include a feedback circuit similar to that discussed in conjunction with FIGS. 1A to 2D.

FIG. 2F illustrates a schematic diagram of an exemplary massage device 260, according to some implementations of the present disclosure. In some implementations, massage device 260 may be a nipple or clitoral massage device, such as a licking vibrator, a sucking vibrator, or a rose vibrator.

As shown in FIG. 2F, massage device 260 may include a casing 271 with a contact region 262 in a first end (e.g., a stimulating end) of massage device 260. A first stimulator 2611 (e.g., an implementation of stimulator 101 in FIG. 1, stimulator 201 in any of FIGS. 2A to 2D, or stimulator 2411 in FIG. 2E), a sensor 263 (e.g., an implementation of sensor 103 in FIG. 1, sensor 203 in any of FIGS. 2A to 2D, or sensor 243 in FIG. 2E), a second stimulator 2613 (e.g., an implementation of stimulator 101 in FIG. 1, stimulator 201 in any of FIGS. 2A to 2D, or stimulator 2413 in FIG. 2E), and a controller (e.g., an implementation of controller 113 in FIG. 1) may be disposed in casing 271. In addition, massage device 260 may further include a hole 2621 within or coupled to contact region 262 for generating airflow into or out of hole 2621.

In some implementations, first stimulator 2611 may have an airflow generator coupled thereto or embedded therein so as to provide airflow via hole 2621 or contact region 262. The airflow may be provided with or without physical contact. When massage device 260 is in contact with a human body of a user, positive or negative pressure (as compared to the atmospheric pressure surrounding massage device 260) may be generated by, for example, controlling the airflow direction through hole 2621, thus bringing pleasurable experience to the user. The speed, interval, intensity, or direction of the airflow may be adjusted by an operator of massage device 260 via the controller and first stimulator 2611. It is noted that first stimulator 2611 may include one or more types of motor, heat generator, or airflow generator. For example, when both an airflow generator and a heat generator are implemented in first stimulator 2611, massage device 200 may generate airflow and simultaneously transmit heat via contact region 262 to a human body.

Second stimulator 2613 may perform one or more functions, such as vibration, protrusion, retraction, or movement in any other manner, but via a region different from contact region 262. The region may be located at a second end (e.g., a hand-held end) of casing 271. Second stimulator 2613 may be implemented as one or more of a motor, a heat generator, or a combination of any of these types of stimulators. It is noted that second stimulator 2613 is only an exemplary implementation in massage device 260. In some implementations, second stimulator 2613 may be omitted.

Similar to sensor 203 in FIGS. 2A to 2D and sensor 243 in FIG. 2E, sensor 263 is configured to detect a status of contact region 262. The status of contact region 262 may include one or more of the following parameters: temperature, moisture, external pressure, or area of contact. To detect different parameters, sensor 263 may be implemented as different types of sensors, which have been described above in conjunction with sensor 103 and thus will not be repeated herein. According to the present disclosure, sensor 263 is not only capable of measuring the absolute value of one or more of the parameters, but also detecting a change thereof. The change may trigger an action of massage device 260 that is proportional to the change.

At least one of first stimulator 2611 or second stimulator 2613 may be further configured to execute a predetermined action in response to the status of contact region 262. The predetermined action includes providing or adjusting at least one of vibration, protrusion, retraction, heat, or airflow via contact region 242. The examples for one particular stimulator are similar to stimulators 201, 2411, and 2413 discussed in conjunction with FIGS. 2A to 2D, and thus will not be repeated herein. It is noted that since first stimulator 2611 and second stimulator 2613 are distinct components of massage device 260, the predetermined actions executed by these two stimulators may or may not be the same. In some implementations, in response to a change of one of the parameters detected by sensor 263, the executed action may be proportional to the change of the detected parameters, which is similar to that discussed in conjunction with FIGS. 2A to 2E.

Similar to contact regions 202 and 242, contact region 262 may include at least a portion of an outer surface of casing 271 and is configured to be in contact with a human body. In some implementations, as shown in FIG. 2F, both first stimulator 2611 and sensor 263 may be underneath the portion of the outer surface of casing 271. In some implementations, similar to that shown in FIG. 2B, casing 271 may have an opening (not shown) at contact region 262, so that first stimulator 2611 may be at least partially exposed at the opening. Similar to cover 214, in some implementations, casing 271 may be at least partially enclosed by a cover (not shown) at contact region 262. The material of the cover is softer than that of casing 271. In some implementations, the cover may include an outer shell (similar to outer shell 213) and an elastic layer (similar to elastic layer 215). In some implementations, at least one of the cover, the outer shell, or the elastic layer is detachable from casing 271. In some implementations, at least one of the cover, the outer shell, or the elastic layer has an opening that matches the opening of casing 271.

In some implementations, as shown in FIG. 2F, massage device 260 may further include at least one of a button 265 or a charging port 267 disposed on casing 271. It is noted that the locations and electric connectivity (e.g., via wire leads) of button 265 and charging port 267 may be the same as or similar to those discussed in conjunction with FIGS. 2A to 2E, and thus will not be repeated herein.

As shown in FIG. 2F, a controller (e.g., controller 113 in FIG. 1) may be disposed in casing 271 and configured to read the status of contact region 262 and control first stimulator 2611 and second stimulator 2613 to execute the predetermined action in response to the status of contact region 262. The controller may include a feedback circuit similar to that discussed in conjunction with FIGS. 1A to 2E.

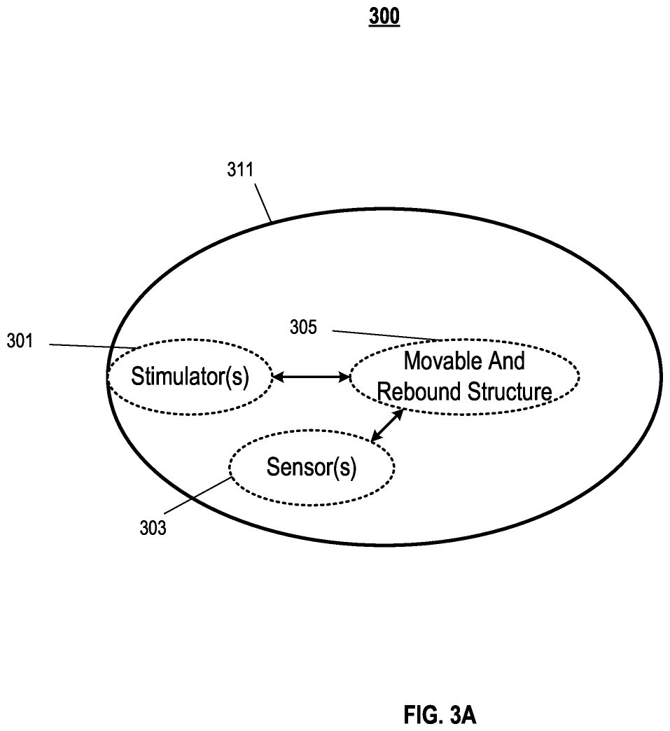

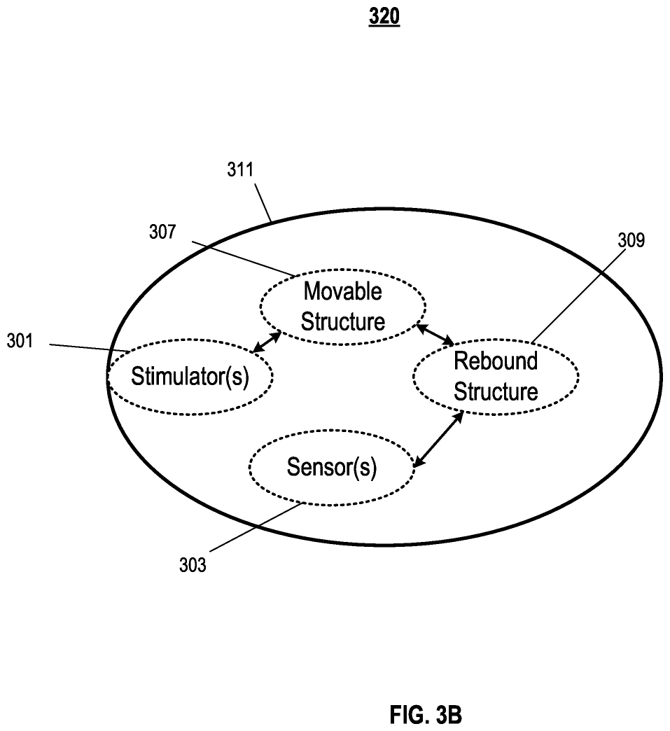

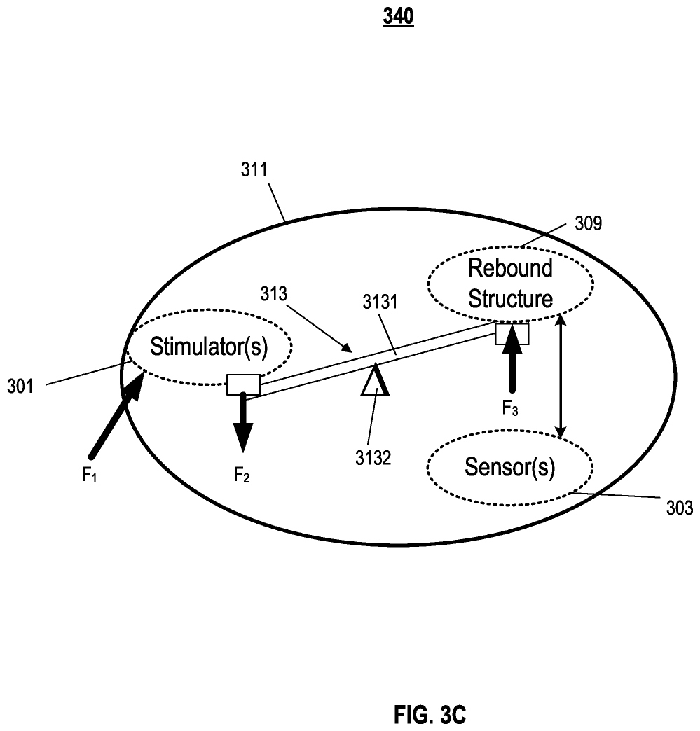

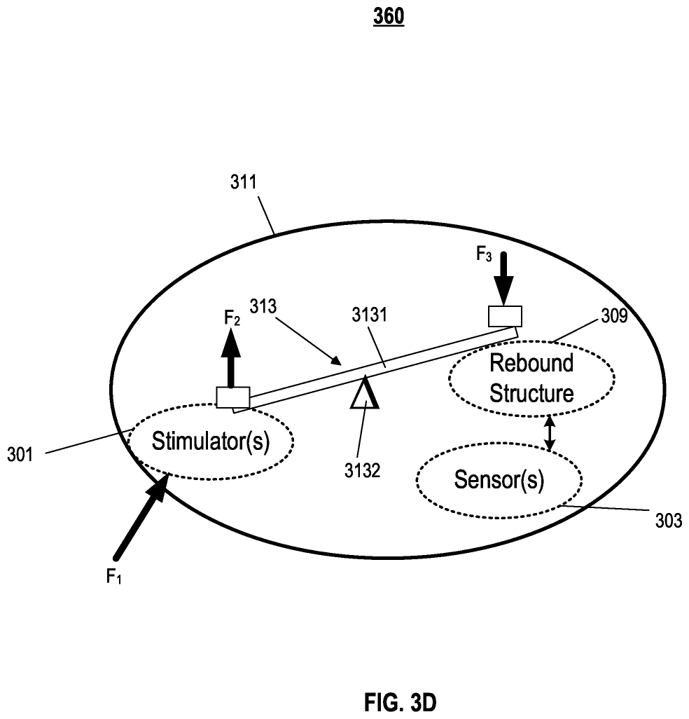

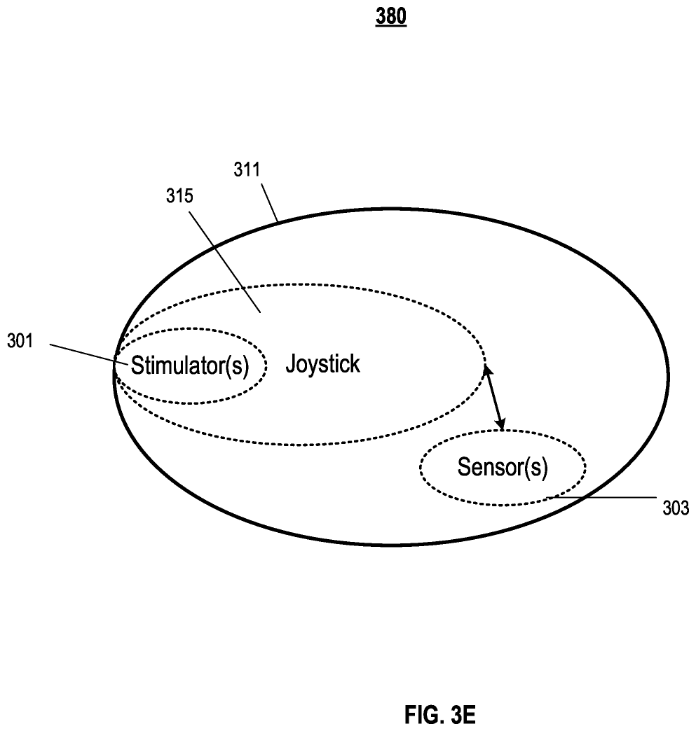

FIGS. 3A-3E illustrate schematic diagrams of exemplary massage devices 300, 320, 340, 360, and 380, each including an exemplary interconnect structure, according to some implementations of the present disclosure. In some implementations, massage device 300, 320, 340, 360, and 380 may be a small massage device that can be held by one hand or palm, such as a mini vibrator, a mini massage wand, a soft touch vibrator, a wearable vibrator, or a panty vibrator.

As shown in FIG. 3A, massage device 300 may include a casing 311, a stimulator 301 (e.g., an implementation of stimulator 101 in FIG. 1, stimulator 201 in any of FIGS. 2A to 2D, stimulators 2411 or 2413 in FIG. 2E, or stimulators 2611 or 2613 in FIG. 2F), a sensor 303 (e.g., an implementation of sensor 103 in FIG. 1, sensor 203 in any of FIGS. 2A to 2D, sensor 243 in FIG. 2E, or sensor 263 in FIG. 2F), and an interconnect structure (e.g., movable and rebound structure 305) disposed in casing 311 and coupled between sensor 303 and stimulator 301.

According to the present disclosure, movable and rebound structure 305 may be any structure that allows stimulator 301 to move into a new position and rebound back to a previous position. In an example, rebound component of movable and rebound structure 305 may be a micro airbag that deforms when pressed and restores to its original form when the pressure is released. Movable and rebound structure 305 may transmit a force to the sensor upon being compressed and rebound when the force decreases or disappears. The transmission may be performed while stimulator 301 is in operation, such as vibration or generating heat or airflow. For example, movable and rebound structure 305 may include a thrust device and a spring coupled to the thrust device such that stimulator 301, when being pressed, is pushed into a new position and, after being released, is restored to a previous position. Also, when stimulator 301 receives external pressure, movable and rebound structure 305 transmits the pressure to sensor 303. The transmission may be in the form of a physical force or an electric signal. Upon receiving the transmission, sensor 303 generates a signal for the controller (e.g., controller 113 in FIG. 1). When the external pressure reduces or disappears (e.g., stimulator 301 is released), the pressure transmitted by movable and rebound structure 305 to sensor 303 also reduces or disappears, and sensor 303 may generate another signal indicating the reduction or disappearance of the pressure for the controller. As a result, sensor 203 may detect a change of the external pressure and notify the controller, which in turn may control certain predetermined actions accordingly.

In some implementations, stimulator 301 may perform vibration upon start of the operation of massage device 300. The level of vibration intensity of stimulator 301 may be an initial operation intensity. When stimulator 301 receives external pressure, such as being pressed against a portion of a human body via a contact region (not shown) of massage device 300, the controller provides feedback to stimulator 301 to cause it to vibrate with more intensity. When the external pressure decreases, such as being moved away to another portion of the human body, the controller provides feedback to stimulator 301 to cause it to vibrate with less intensity. When external pressure is removed, stimulator 301 may restore to the initial operation intensity. In this way, similar to stimulator 201, stimulator 301 may execute a predetermined action in response to the status of the contact region (e.g., level of external pressure). In some implementations, stimulator 301 may deliver vibrations proportional to the change of the detected external pressure, similar to stimulator 201 discussed above. It is noted that the feedback mechanism upon stimulator 301 being pressed or released is just one example, the feedback mechanism can involve any other component arranged in the stimulating end or the contact region that transmits various types of parameters.

In some implementations, the interconnect structure can have two or more sub-structures. For example, in FIG. 3B, massage device 320 may include a movable structure 307 and a rebound structure 309, each coupled between stimulator 301 and sensor 303. Rebound structure 309 may be the same as or similar to the rebound component of movable and rebound structure 305 discussed in conjunction with FIG. 3A, and may transmit a force to the sensor upon being compressed and rebound when the force decreases or disappears. The transmission may be performed while stimulator 301 is in operation, such as vibration or generating heat or airflow. For example, movable structure 307 may include a shaft and rebound structure 309 may include a spring or an elastic pad. When stimulator 301 receives external pressure, the pressure is transmitted via movable structure 307 and rebound structure 309 respectively to sensor 303. The transmission may be in the form of a physical force or an electric signal. Upon receiving the transmission, sensor 303 may generate a signal for the controller (e.g., controller 113 in FIG. 1). The feedback mechanism of massage device 320 is similar to that discussed in conjunction with FIG. 3A and thus will not be repeated herein.

In some implementations, the interconnect structure can have a leverage structure and a rebound structure. As shown in FIG. 3C, massage device 340 may include a leverage structure 313 and a rebound structure 309, each coupled between stimulator 301 and sensor 303. Rebound structure 309 may be the same as or similar to the rebound component of movable and rebound structure 305 discussed in conjunction with FIG. 3A. In some implementations, leverage structure 313 may include a first end coupled to stimulator 301, a second end coupled to rebound structure 309, a beam 3131, and a fulcrum 3132 between the first end and the second end. When external pressure F₁ is exerted upon stimulator 301 via a contact region of massage device 340, the first end of leverage structure 313 receives an input force F2 at the first end of leverage structure 313, which is translated to an output force F3 at the second end of leverage structure 313.

FIG. 3D illustrates massage device 360 that has the same components as massage device 340, including stimulator 301, sensor 303, rebound structure 309, leverage structure 313, which further includes beam 3131 and fulcrum 3132. The positions of stimulator 301 and rebound structure 309 are different from those in FIG. 3C, so that when external pressure F1 is applied, the direction of input force F2 at the first end of leverage structure 313 is different from that in FIG. 3C. As a result, the direction of output force F3 at the second end of leverage structure 313 is also different from that in FIG. 3C.

The output force F₃ indicates the properties of external force F₁, and may be transmitted as a physical force or an electric signal to sensor 303. The transmission may be performed while stimulator 301 is in operation, such as vibration or generating heat or airflow. Sensor 303 may generate another signal for a controller (e.g., controller 113 in FIG. 1) indicating the strength of external pressure F₁ or the change of the strength. The feedback mechanism of massage device 340 is similar to that discussed in conjunction with FIG. 3A and thus will not be repeated herein. It is noted that the structure and position of leverage structure 313 (including those of beam 3131 and fulcrum 3132) and the orientation of external pressure F₁, input force F₂, and output force F₃ are for illustrative purpose only, and a person skilled in the pertinent art would understand, with the teaching disclosed herein, that other configurations of leverage structure 313 and orientations of various forces may also be applied to massage device 340. For example, as to leverage structure 313, a compound lever that comprises several leverage structures may be used.

In some implementations, the interconnect structure can be a joystick structure 315, which in turn may be coupled to or include stimulator 301, as shown in FIG. 3E. Further, joystick structure 315 may be coupled to or includes a sensor 303. For example, joystick structure 315 may include a shaft coupled to stimulator 301, and a rotatable casing coupled to the shaft and capable of rotating in multiple directions. When external pressure is exerted upon stimulator 301, a physical force may be transmitted to the rotatable casing via the shaft. Accordingly, the rotatable casing may transmit to sensor 303 a physical force or an electric signal indicating the application of external pressure to stimulator 301. The transmission may be performed while stimulator 301 is in operation, such as vibration or generating heat or airflow. When stimulator 301 and the shaft move pressed, sensor 303 may receive the transmission indicating the direction and the level of the rotation, and further generate a signal for the controller (e.g., controller 113 in FIG. 1) indicating the same. When stimulator 301 and the shaft are released, sensor 303 may generate a signal for the controller indicating reduction or disappearance of the external pressure. The feedback mechanism of massage device 360 is similar to that discussed in conjunction with FIG. 3A and thus will not be repeated herein.

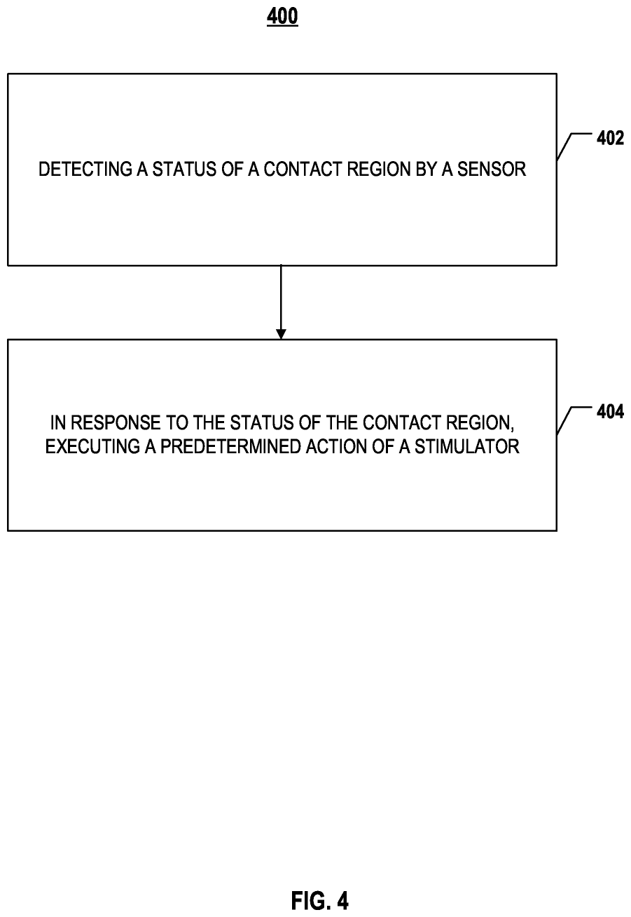

FIG. 4 illustrates a flowchart for operating an exemplary massage device, according to various embodiments of the present disclosure.

Referring to FIG. 4, method 400 starts at operation 402 in which a sensor detects a status of a contact region of a massage device. Using FIG. 2A as an example, massage device 200 may include a casing 211 with a contact region 202 in a first end (e.g., a stimulating end) of massage device 200. A stimulator 201 (e.g., an implementation of stimulator 101 in FIG. 1), a sensor 203 (e.g., an implementation of sensor 103 in FIG. 1), and a controller (e.g., an implementation of controller 113 in FIG. 1) may be disposed in casing 211. Sensor 203 is configured to detect a status of contact region 202. The status of contact region 202 may include one or more of the following parameters: temperature, moisture, external pressure, or area of contact. According to the present disclosure, sensor 203 is not only capable of measuring the absolute value of one or more of the parameters, but also detecting a change thereof. The change may trigger an action of massage device 200 that is proportional to the change. Subsequently, the status of contact region 202 may be transmitted to the controller.

Method 400 proceeds to operation 404, as illustrated in FIG. 4, in which a predetermined action is executed in response to the status of contact region. As shown in FIG. 2A, stimulator 201 is further configured to execute a predetermined action in response to the status of contact region 202. The predetermined action includes providing or adjusting at least one of vibration, protrusion, retraction, heat, or airflow via contact region 202. It is noted that FIG. 2A is only illustrated as an example, and method 400 is applicable to any other implementation in the present disclosure, including those described in conjunction with FIGS. 2B to 3E.

In some implementations, method 400 may further include a feedback step, in which feedback is provided to the stimulator according to a signal representing the detected status of the contact region. The signal may include a value range indicating the change of parameters, and as a result, stimulator may change the intensity of its vibrations proportionally according to the change.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A massage device, comprising:
a casing comprising a contact region;
a sensor disposed in the casing and configured to detect a status of a contact region; and
a stimulator at least partially disposed in the casing and configured to execute a predetermined action in response to the status of the contact region.

2. The massage device of claim 1, wherein the stimulator and the sensor are coupled via an interconnect structure, wherein the interconnect structure transmits a physical force or an electric signal to the sensor indicating external pressure received by the stimulator.

3. The massage device of claim 2, wherein the interconnect structure comprises a rebound structure, and
wherein the rebound structure is configured to transmit a force to the sensor upon being compressed and to rebound when the force decreases or disappears.

4. The massage device of claim 3, wherein the rebound structure comprises one of an elastic pad or a joystick structure.

5. The massage device of claim 4, wherein the interconnect structure further comprises at least one of a movable structure or a leverage structure between the sensor and at least one of the stimulator and the rebound structure.

6. The massage device of claim 1, further comprising:
a controller disposed in the casing and configured to control the stimulator to execute the predetermined action in response to the status of the contact region.

7. The massage device of claim 6, wherein the controller comprises a feedback circuit configured to provide feedback to the stimulator according to a signal representing the detected status of the contact region.

8. The massage device of claim 1, wherein the casing is at least partially enclosed by a cover at the contact region of the casing, and a material of the cover is softer than that of the casing.

9. The massage device of claim 8, wherein the cover is detachably attached to the casing.

10. The massage device of claim 9, wherein the cover encloses the contact region and at least a portion of an outer surface of the casing.

11. The massage device of claim 8, wherein the cover further comprises an outer shell and an elastic layer disposed between the casing and the outer shell, and
wherein the elastic layer is integrated with the outer shell or separate from both the outer shell and the casing.

12. The massage device of claim 9, wherein at least one of the cover, the outer shell, or the elastic layer comprises an opening matching an opening of the casing, and
wherein the stimulator is at least partially exposed by the opening of the casing and the opening of at least one of the cover, the outer shell, or the elastic layer.

13. The massage device of claim 8, further comprising:
at least one of a button or a charging port disposed on a control region, wherein the control region is provided at an end different from an end where the contact region is provided.

14. The massage device of claim 13, wherein the cover has one or more openings in a surface region corresponding to at least one of the control region, the button, or the charging port.

15. The massage device of claim 13, wherein a detachable cap is provided at each location of the one or more openings.

16. The massage device of claim 1, wherein the casing comprises an opening at the contact region, and
wherein the stimulator is at least partially exposed at the opening of the contact region.

17. The massage device of claim 1, wherein the status of the contact region comprises at least one of the following parameters:
temperature, moisture, external pressure, or area of contact.

18. The massage device of claim 17, wherein the predetermined action comprises providing or adjusting at least one of vibration, protrusion, retraction, heat, or airflow via the contact region.

19. The massage device of claim 18, wherein the stimulator, in response to a change of one of the parameters detected by the sensor, delivers vibrations via the contact region proportional to the change of the parameter.

20. A method for operating a massage device, comprising:
detecting a status of a contact region of the massage device by a sensor, and
in response to the status of the contact region of the massage device, executing a predetermined action by a stimulator.
